(19) United States
(12) Patent Application Publication
(10) Pub. No.: US 2007/0233767 A1
(43) Pub. Date: Oct. 4, 2007

(54) Rotator/shifter arrangement

(76) Inventor: Jeremy Anderson, Hillsboro, OR (US)

Correspondence Address: Lee & Hayes, PLLC;C/O Intellevate, P.O. Box 52050, Minneapolis, MN, 55402, US

(21) Appl. No.: 11/395,364

(22) Filed: Mar. 31, 2006

(51) Int. Cl. G06F 7/38

(52) U.S. Cl. 708/490

(57) ABSTRACT

Embodiments related to rotator/shifter arrangements are presented herein.

### BACKGROUND

Numerical rotate and shift operations are used in modem microprocessors and other integrated circuits (ICs). In a rotate operation, also known as a circular shift operation, rightmost and leftmost positions of a register or a storage device are considered as being adjacent during a shift. Thus, a rotate left operation shifts all of the bits of an operand left by one or more positions and the most significant bits (MSBs) are shifted around to become the least significant bits (LSBs). In a rotate right operation, all of the bits of an operand are shifted right by one or more positions and the LSBs are shifted around to become the MSBs.

The shift operations include: logical shift and arithmetic shift. The logical and arithmetic shift operations are possible using a rotator device. For a logical shift right, the n-LSBs are shifted around to become the MSBs. Then, those bits shifted around are replaced by zeros (0). For a logical shift left, the n-MSBs are shifted around to become the LSBs. Then, those bits shifted around are replaced by zeros. An arithmetic shift right operation operates in the same manner as a logical shift right, with the exception being that the MSBs of the resulting shift operation is padded in from the most significant position of the original operand. Ones (1) are generally added instead of the zeros. An arithmetic shift left operation produces the same result as the logical shift left.

Conventional rotator/shifter devices may reduce the efficiency of advanced microprocessor and other IC architectures. For example, a conventional rotator/shifter implemented in a 32-bit microprocessor may severely handicap the performance of the processor when the rotator/shifter is used by shift intensive applications. This performance degradation is generally attributed to the number of bit interconnects implemented by conventional rotator/shifter devices.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is a circuit diagram illustrating an exemplary implementation of a rotator/shifter arrangement.

FIG. 2A-2D illustrates a logical shift left by one (1) using the rotator/shifter arrangement illustrated in FIG. 1.

FIG. 3A-3D illustrates a logical shift right by two (2) using the rotator/shifter arrangement illustrated in FIG. 1.

FIG. 4A-4D illustrates a right rotate by two (2) using the rotator/shifter arrangement illustrated in FIG. 1.

FIG. 5 shows an example procedure for performing rotate and/or shift operations. In one implementation, the example procedure is made possible through the use of the rotator/shifter arrangement illustrated in FIG. 1.

FIG. 6 illustrates an exemplary implementation of a computing device that is operable to employ one or more rotator/shifter arrangements.

### DETAILED DESCRIPTION

Rotator/shifter arrangements can be found in many different integrated circuits (ICs). Such ICs include processors, memories, and the like. Rotator/shifter arrangements often handle arithmetic functions, such as multiplication and division, variable-length coding, encryption, byte swaps, hi-lo operations and bit-indexing. The implementations described herein may be able to perform at least one or more of the following logic operations: logical shift right, arithmetic shift right, rotate right, logical shift left, arithmetic shift left, and rotate left. Table 1 provides an example of each of these operations. In Table 1, the bit vector or operand used for each operation is represented as A₃₁, A₃₀, A₂₉, A₂₈, A₂₇, . . . , A₄, A₃, A₂, A₁, A₀. Each of the examples shown in the table has undergone a shift or rotate amount of three (3) bits.

TABLE 1

| Operation | Result |
|---|---|
| 3-bit logical | 0, 0, 0, A₃₁, A₃₀, A₂₉, A₂₈, A₂₇, . . . , A₄, A₃ |
| shift right | |
| 3-bit arithmetic | A₃₁, A₃₁, A₃₁, A₃₁, A₃₀, A₂₉, A₂₈, A₂₇, . . . , A₄, A₃ |
| shift right | |
| 3-bit rotate right | A₂, A₁, A₀, A₃₁, A₃₀, A₂₉, A₂₈, A₂₇, . . . , A₄, A₃ |
| 3-bit logical | A₂₈, A₂₇, . . . , A₄, A₃, A₂, A₁, A₀, 0, 0, 0 |
| shift left | |
| 3-bit arithmetic | A₂₈, A₂₇, . . . , A₄, A₃, A₂, A₁, A₀, 0, 0, 0 |
| shift left | |
| 3-bit rotate | A₂₈, A₂₇, . . . , A₄, A₃, A₂, A₁, A₀, A₃₁, A₃₀, A₂₉ |
| left | |

The following disclosure is organized to describe initially various rotator/shifter arrangements. This description is followed by a discussion of a number of exemplary outputs from the described rotator/shifter arrangements. Then, a discussion of procedures related to the described rotator/shifter arrangements is provided. Finally, an exemplary implementation of a computing device that is operable to employ one or more rotator/shifter arrangements is described.

Rotator/Shifter Arrangement

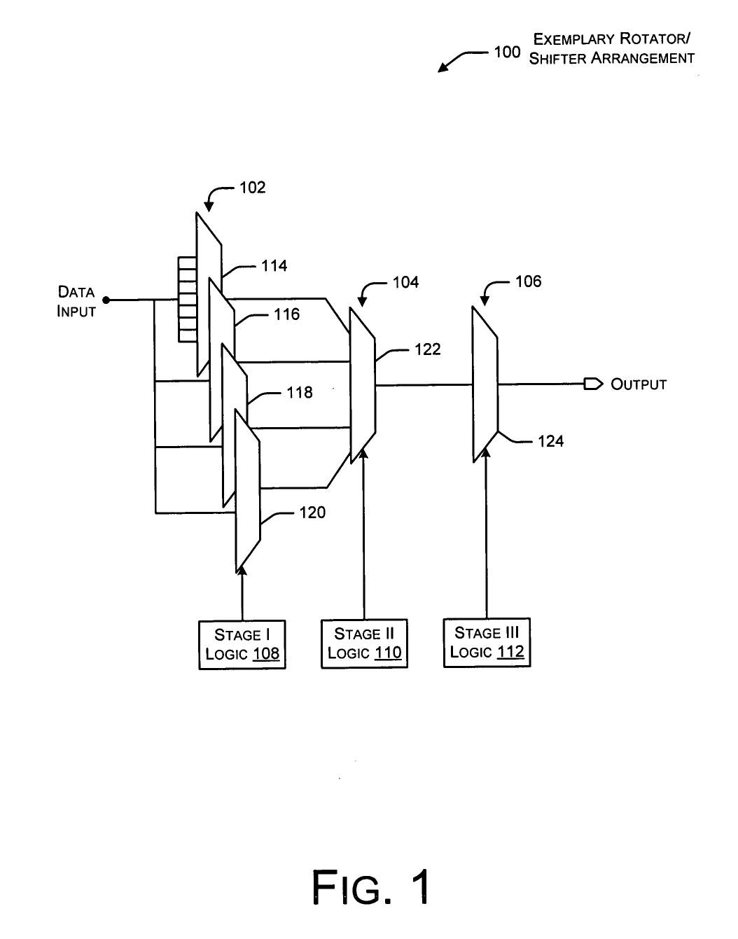

FIG. 1 illustrates an exemplary implementation of a rotator/shifter arrangement 100. The data input to the rotator/shifter arrangement 100 may be a double word (32-bit) operand. The rotator/shifter 100 is also capable of handling word (16-bit) operands and byte (8-bits) operands as well.

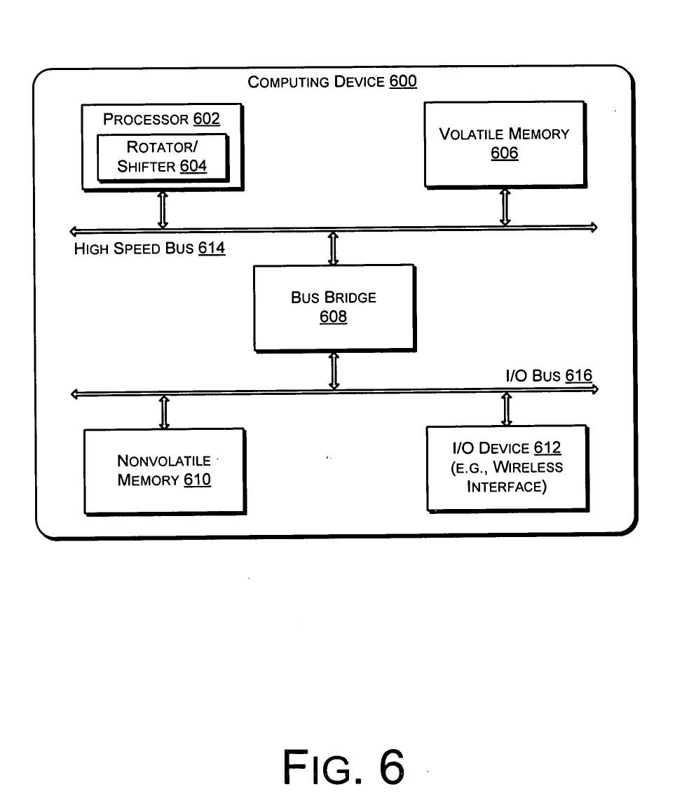

The rotator/shifter 100 may include three multiplexer stages (102, 104, and 106). Each of the multiplexer stages 102, 104 and 106 is controlled by a stage logic 108, 110, or 112. More specifically, the multiplexer stage 102 is controlled by the stage I logic 108; the multiplexer stage 104 is controlled by the stage II logic 110; and the multiplexer stage 106 is controlled by the stage III logic 112. Logic provided by each of the stage logic sections 108, 110, and 112 instructs components of the respective multiplexer stages 102, 104, and 106 of the type of operation to perform (e.g., logical shift right, logical shift left, rotate right, etc.) and what action must occur to process such an operation. Although not shown in the figure, a device employing the rotator/shifter arrangement 100, such as a microprocessor or other integrated circuit (IC), may make use of the stage logic sections 108, 110, and 112 to carryout rotate and/or shift operations required by executable program instructions stored in volatile/nonvolatile memory. FIG. 6 illustrates an exemplary implementation of a computing device that employs one or more rotator/shifter arrangements that may be used by executable program instructions stored in volatile/nonvolatile memory.

In FIG. 1, the multiplexer stage 102 may include 8-bit multiplexers 114-120. Under the control of the stage 1 logic 108, the 8-bit multiplexers 114-120 may process a double word (32-bit) operand. More specifically, the 8-bit multiplexer 114 processes bits 31-24 of the operand; the 8-bit multiplexer 116 processes bits 23-16 of the operand; the 8-bit multiplexer 118 processes bits 15-8 of the operand; and the 8-bit multiplexer 120 processes bits 7-0 of the operand.

Unlike known rotate and shifting arrangements that traverse long wires when performing rotate and shifting operations, the rotator/shifter arrangement 100 compartmentalizes these operations. By compartmentalizing rotate and shifting operations, in one implementation, the rotator/shifter arrangement 100 discharges low capacitance and operates with good speed.

To achieve the mentioned compartmentalization, the multiplexer stage 102 restricts rotate and shifting operations to within a byte boundary (8 bits). Therefore, the 8-bit multiplexer 114 performs rotate and shifting operations on bits 31-24 of an input operand; the 8-bit multiplexer 116 performs rotate and shifting operations on bits 23-16 of an input operand; the 8-bit multiplexer 118 performs rotate and shifting operations on bits 15-8 of an input operand; and the 8-bit multiplexer 120 performs rotate and shifting operations on bits 7-0 of an input operand.

The rotate and shifting operations performed by the multiplexers 114-120 do not produce a fully rotated or shifted version of the operand received by the rotator/shifter 100. This is because the operations performed by the multiplexers 114-120 are restricted to respective byte boundaries of the input operand. Each of the multiplexers 114-120 produces an 8-bit operand that includes rotated digits from the input operand, and combining these four 8-bit operands to create a 32-bit operand would not produce an expected rotated or shifted operation.

Under control of the stage II logic 110, the multiplexer stage 104 processes the four 8-bit operands created by the multiplexer stage 102. The multiplexer stage 104 includes a 32-bit multiplexer 122 that receives each of the 8-bit operands. The multiplexer 122 combines the 8-bit operands and outputs a 32-bit operand. The process of combining the 8-bit operands includes repositioning incorrectly positioned bits associated with each of the 8-bit operands produced by the multiplexers 114-120. The stage II logic 110 provides logic for repositioning the incorrectly positioned bits.

The multiplexer stage 106 receives the 32-bit operand output from the multiplexer stage 106. This multiplexer stage 106 includes a 32-bit multiplexer 124 that, under control provided by the stage III logic 112, performs the required “kill value” insertion into one or more positions related to the received 32-bit operand. The kill value insertion may call for the insertion of one or more zeros (0), or the use of the most significant bit for arithmetic shift right operations.

To summarize the above, in one implementation, the exemplary rotator/shifter arrangement 100 performs an initial rotate/shift operation on four 8-bit operands derived from a 32-bit input operand. In one implementation, each initial rotate/shift operation of the four 8-bit operands traverses at most 7 bit positions. The exemplary rotator arrangement 100, in one implementation, also assembles the four 8-bit operands, where each 8-bit operand has one or more rotated/shifted bits, as a complete 32-bit operand. The process of assembling the four 8-bit operands includes repositioning incorrectly positioned bits so that the resultant 32-bit operand is comprised of properly positioned bits. If required, kill value insertion is performed on the 32-bit operand.

As mentioned, the rotator/shifter 100 is also capable of handling word (16-bit) operands and byte (8-bits) operands. A word operand may be processed by the multiplexers 114 and 116, where a byte operand may be handled alone by the multiplexer 114.

Depending on the shift or rotate operation count (e.g., 3-bit rotate right), the multiplexer stage 102 may simply pass an input operand to the multiplexer stage 104 unmodified. This may occur when the shift or rotate operation count is divisible by 8, or when logic does not specify a shift or rotate operation is required. For example, if an 8-bit rotate right is desired, the multiplexer stage 102 passes an input operand through to the multiplexer stage 104 unmodified. The multiplexer stage 104 completes the 8-bit rotate by moving bits in byte-sized segments.

The rotator/shifter arrangement 100 may be augmented to enable processing of double-precision operands (64-bit). This is achieved by cascading two rotator/shifter arrangements 100; such a cascaded arrangement is capable of performing a logical shift left operation. One of the two rotator/shifter arrangements in the cascaded structure receives the first 32 bits from the operand and the other rotator/shifter arrangement receives the second 32 bits from the operand. The logical shift left operation is performed sequentially by the cascaded arrangement. This ensures that kill value logic associated with the first 32 bits of the operand is available and can be used during the processing of the second 32 bits of the 64-bit operand.

Although the discussed implementations indicated that at most 7 bit positions of each 8-bit operand are traversed, this is by way of example only. That is, any plurality of bit positions may be traversed, depending upon design particulars of a rotator/shifter arrangement.

Exemplary Rotator/Shifter Output

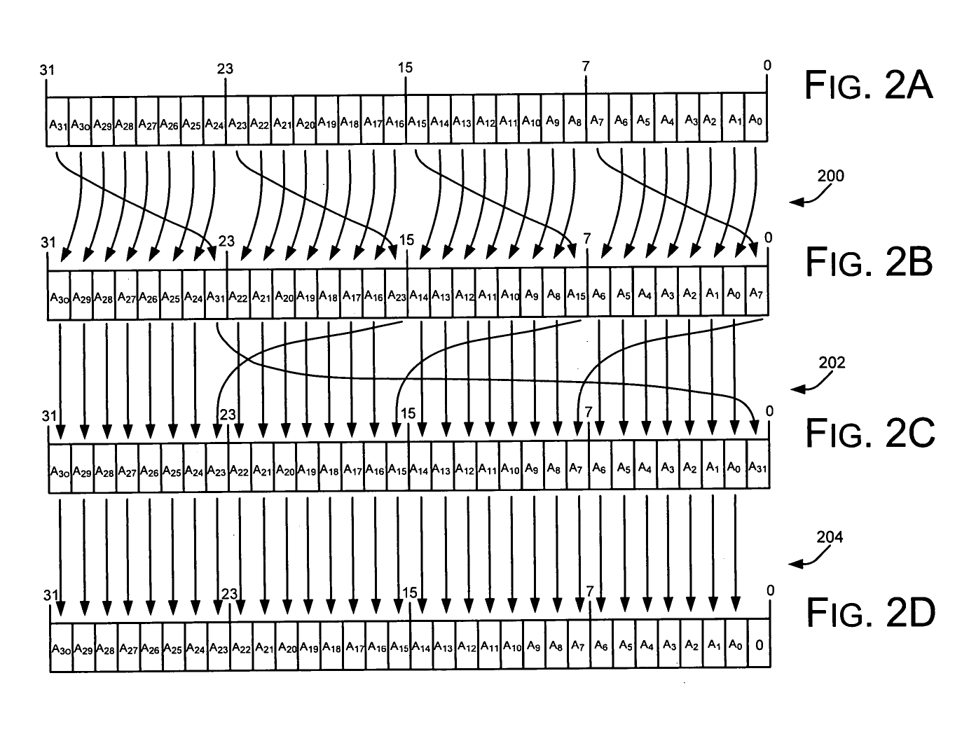

FIGS. 2-4 illustrate exemplary rotate/shift operations that may be performed by the described exemplary implementations. In one implementation, the rotator/shifter arrangement 100 illustrated in FIG. 1 performs the rotate/shift operations illustrated in FIGS. 2-4. The illustrated operations are merely illustrative of the capabilities of the rotator/shifter arrangement 100. More specifically, the rotator/shifter arrangement 100 is capable of performing any n-bit rotate/shift operation on an m-bit operand, where n is the number of bits to be rotated/shifted and m is the number of bits in the operand.

FIGS. 2A-2D illustrate a 1-bit logical shift left operation performed by the rotator/shifter 100. Each of the figures includes 32 bit placeholders identified by the numbers 31-0. The bit holders may be vector or bit positions associated with one or more registers incorporated in one or more multiplexers. The operand values occupying the bit positions are represented by: A₃₁, A₃₀, A₂₉, A₂₈, A₂₇, . . . , A₄, A₃, A₂, A₁, A₀.

The 32-bit operand illustrated in FIG. 2A is received by the multiplexer stage 102. In particular, bits 31-24 are received by the multiplexer 114, bits 23-16 are received by the multiplexer 116, bits 15-8 are received by the multiplexer 118, and bits 7-0 are received by the multiplexer 120. Each respective multiplexer 114-120 performs a 1-bit logical shift left on the received bits. This entails shifting bits left 1-bit place and moving the bit in the most significant bit (MSB) position to the least significant bit (LSB) position. As is seen in the figure, the shifting and moving of bits (operations 200) by the multiplexer stage 102 does not exceed more than 8 bit positions. In one implementation, the operations 200 are controlled by the stage I logic 108.

The 32-bit operand illustrated in FIG. 2B is received by the multiplexer stage 104, in particular, the multiplexer 122. The multiplexer 122 corrects the locations of the bits that are positioned incorrectly. Properly positioned bits are left in their proper positions. Since the rotator/shifter 100 is performing a 1-bit logical shift left, the multiplexer 122 maintains bit positions 31-25, 23-17, 15-9 and 7-1, but moves A₃₁ to bit position 0, A₂₃ to bit position 24, A₁₅ to bit position 16, and A₇ to bit position 8. The foregoing bit movements (operations 202) do not more than 24 bit positions. In one implementation, the operations 202 are led by the stage II logic 110.

The 32-bit operand illustrated in FIG. 2C is received by the multiplexer stage 106, in particular, the multiplexer 124. The multiplexer 124 completes the 1-bit logical shift left operation and outputs the 32-bit operand illustrated in FIG. 2D. Because this is a 1-bit logical shift left operation, the multiplexer 124 kills the bit held in bit position 0 (operation 204). In one implementation, the operation 204 is controlled by the stage III logic 112.

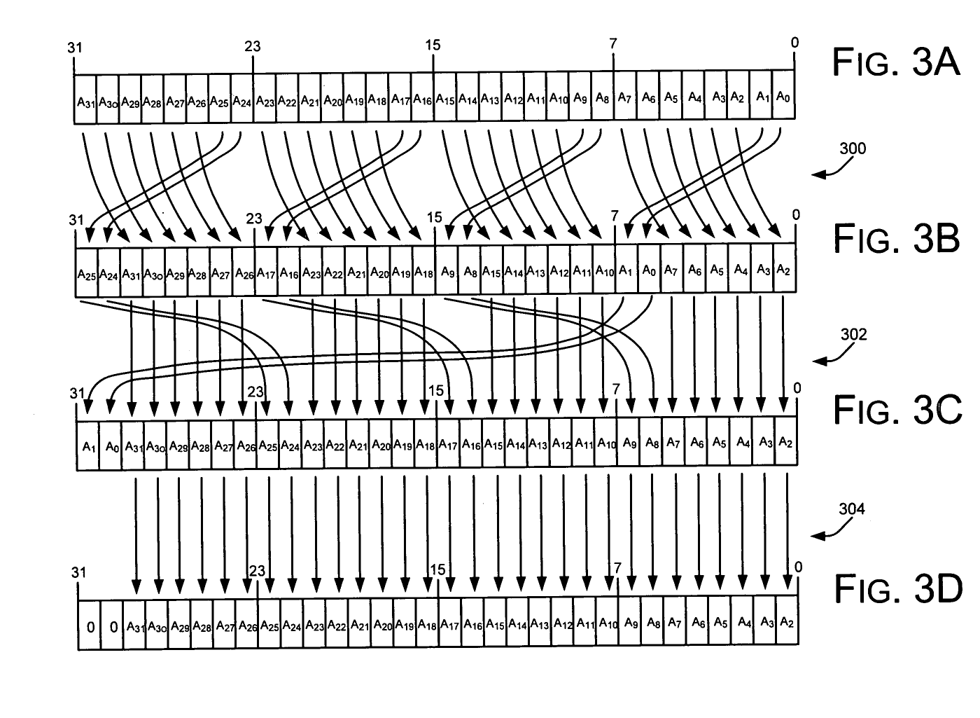

FIGS. 3A-3D illustrate a 2-bit logical shift right operation performed by the rotator/shifter 100. Each of the figures includes 32 bit placeholders identified by the numbers 31-0. The bit holders may be vector or bit positions associated with one or more registers incorporated in one or more multiplexers. The operand values occupying the bit positions are represented by: A₃₁, A₃₀, A₂₉, A₂₈, A₂₇, . . . , A₄, A₃, A₂, A₁, A₀.

The 32-bit operand illustrated in FIG. 3A is received by the multiplexer stage 102. In particular, bits 31-24 are received by the multiplexer 114, bits 23-16 are received by the multiplexer 116, bits 15-8 are received by the multiplexer 118, and bits 7-0 are received by the multiplexer 120. Each respective multiplexer 114-120 performs a 2-bit logical shift right on the received bits. This entails shifting bits right 2-bit places and moving the two bits in the least significant bit (LSB) positions to the most significant bit (MSB) positions. As is seen in the figure, the shifting and moving of bits (operations 300) by the multiplexer stage 102 does not exceed more than 8 bit positions. In one implementation, the operations 300 are controlled by the stage I logic 108.

The 32-bit operand illustrated in FIG. 3B is received by the multiplexer stage 104, in particular, the multiplexer 122. The multiplexer 122 corrects the locations of the bits that are positioned incorrectly. Properly positioned bits are left in their proper positions. Since the rotator/shifter 100 is performing a 2-bit logical shift right, the multiplexer 122 maintains bit positions 29-24, 21-16, 13-8 and 5-0, but moves A₂₅ and A₂₄ to bit positions 23 and 22, respectively, A₁₇ and A₁₆ to bit positions 15 and 14, respectively, A₉ and A₈ to bit positions 7 and 6, respectively, and A₁ and A₀ to bit positions 31 and 30, respectively. The foregoing bit movements (operations 302) do not exceed more than 24 bit positions. In one implementation, the operations 302 are controlled by the stage II logic 110.

The 32-bit operand illustrated in FIG. 3C is received by the multiplexer stage 106, in particular, the multiplexer 124. The multiplexer 124 completes the 2-bit logical shift right operation and outputs the 32-bit operand illustrated in FIG. 3D. Because this is a 2-bit logical shift right operation, the multiplexer 124 kills the bits held in bit positions 31 and 30 (operation 304) and inserts a zero (0) in each position. In one implementation, the operation 304 is controlled by the stage III logic 112.

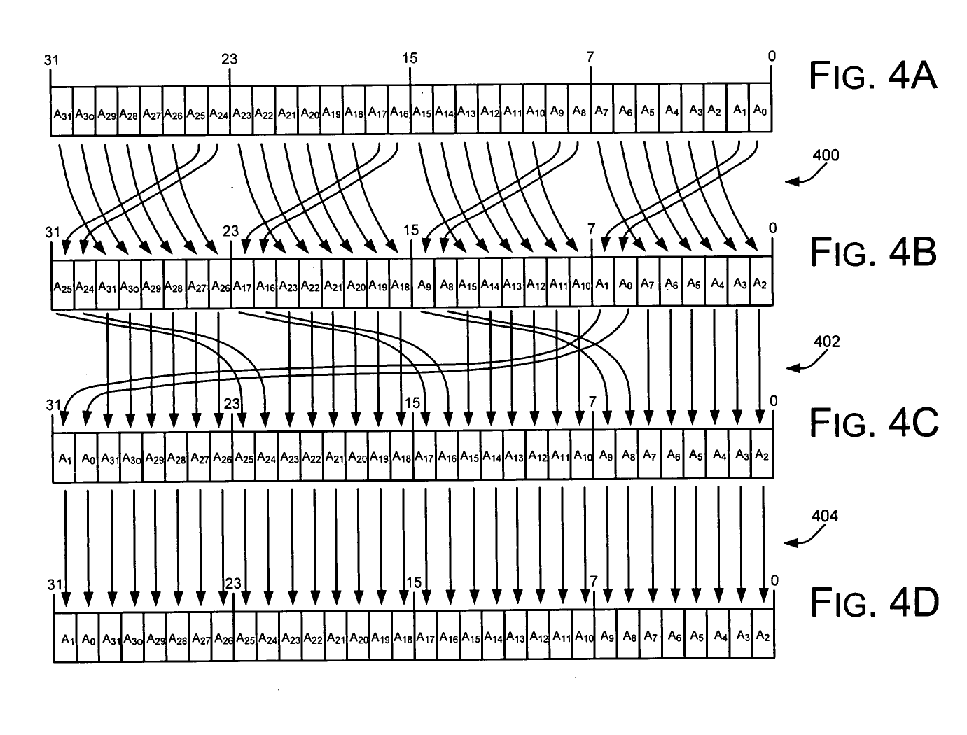

FIGS. 4A-4D illustrate a 2-bit rotate right operation performed by the rotator/shifter 100. Each of the figures includes 32 bit placeholders identified by the numbers 31-0. The bit holders may be vector or bit positions associated with one or more registers incorporated in one or more multiplexers. The operand values occupying the bit positions are represented by: A₃₁, A₃₀, A₂₉, A₂₈, A₂₇, . . . , A₄, A₃, A₂, A₁, A₀.

The 32-bit operand illustrated in FIG. 4A is received by the multiplexer stage 102. In particular, bits 31-24 are received by the multiplexer 114, bits 23-16 are received by the multiplexer 116, bits 15-8 are received by the multiplexer 118, and bits 7-0 are received by the multiplexer 120. Each respective multiplexer 114-120 performs a 2-bit rotate right on the received bits. This entails shifting bits right 2-bit places and moving the two bits in the least significant bit (LSB) positions to the most significant bit (MSB) positions. As is seen in the figure, the shifting and moving of bits (operations 400) by the multiplexer stage 102 does not exceed more than 7 bit positions. In one implementation, the operations 400 are controlled by the stage I logic 108.

The 32-bit operand illustrated in FIG. 4B is received by the multiplexer stage 104, in particular, the multiplexer 122. The multiplexer 122 corrects the locations of the bits that are positioned incorrectly. Properly positioned bits are left in their proper positions. Since the rotator/shifter 100 is performing a 2-bit rotate right, the multiplexer 122 maintains bit positions 29-24, 21-16, 13-8 and 5-0, but moves A₂₅ and A₂₄ to bit positions 23 and 22, respectively, A₁₇ and A₁₆ to bit positions 15 and 14, respectively, A₉ and A₈ to bit positions 7 and 6, respectively, and A₁ and A₀ to bit positions 31 and 30, respectively. The foregoing bit movements (operations 402) do not exceed more than 24 bit positions. In one implementation, the operations 402 are controlled by the stage II logic 110.

The 32-bit operand illustrated in FIG. 4C is received by the multiplexer stage 106, in particular, the multiplexer 124. The multiplexer 124 completes the 2-bit rotate right operation and outputs the 32-bit operand illustrated in FIG. 4D. In particular, because this is a 2-bit rotate right operation, the multiplexer 124 simply outputs (operation 404) the operand received from the multiplexer 122. In one implementation, the operation 404 is controlled by the stage III logic 112.

The operations shown in FIGS. 2-4 are merely illustrative of the capabilities of the rotator/shifter arrangement 100. Again, the rotator/shifter arrangement 100 is capable of performing any n-bit rotate/shift operation, where n is the number of bits to be rotated/shifted.

Procedure

The following discussion describes procedures that may be implemented utilizing the previously described rotator/shifter implementations. Aspects of the procedures may be implemented in hardware, firmware, or software, or a combination thereof. The procedures are shown as a set of blocks that specify operations performed by one or more devices and are not necessarily limited to the order shown for performing the operations by the respective blocks. In portions of the following discussion, reference will be made to the arrangement of FIG. 1.

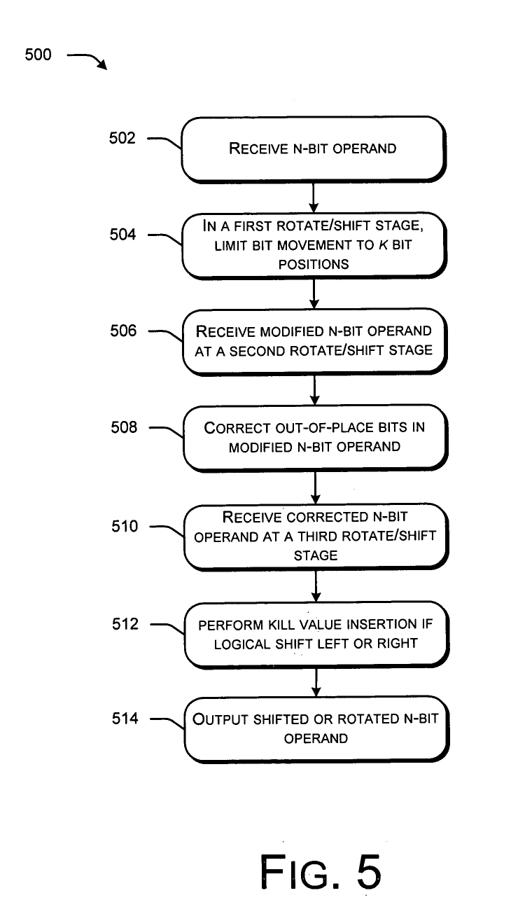

FIG. 5 shows an example procedure 500 that enables output of data from a rotator/shifter, such as the rotator/shifter arrangement 100. The rotator/shifter may be part of a processor, memory, or other IC or device that may use rotate and/or shift logic operations.

At block 502, the first multiplexer stage 102 receives an n-bit operand. At block 504, depending on a logic operation (e.g., logical shift left, logical shift right, etc.), one or more bits associated with n-bit operand may be moved by 8-bit multiplexers associated with the multiplexer stage 102. In one implementation, each bit movement performed by the 8-bit multiplexers does not exceed 7 bit positions. In one implementation, each bit movement performed by the 8-bit multiplexers does not exceed k bit positions.

At block 506, the second multiplexer stage 104 receives the modified n-bit operand from the first multiplexer stage 102. At block 508, the second multiplexer stage 104 corrects incorrectly positioned bits associated with the modified n-bit operand. The multiplexer stage 104 achieves this correction by moving the incorrectly positioned bits to proper bit positions. In one implementation, bit movement does not exceed 24 bit positions. As should be readily understood, the second multiplexer stage 104 may also move or otherwise process bits that are not incorrectly positioned. This occurs, for example, when the first multiplexer stage 102 positions bits and the second multiplexer stage 104 repositions one or more bits in the ordinary course of completing a logical operation (e.g., logical shift left, right, etc.).

At block 510, the third multiplexer stage 106 receives the corrected n-bit operand. At block 512, the third multiplexer stage 106 performs kill value insertion if the logic operation being performed is a logical shift left or right. At block 514, a shifted or rotated n-bit operand is output from the rotator/shifter 100.

Exemplary Devices

FIG. 6 illustrates an exemplary implementation of a computing device 600 that is operable to employ one or more rotators/shifters, such as the rotator/shifter arrangement 100, and related procedures described herein. The computing device 600 may be configured in a variety of ways. For example, the computing device 600 may be configured as a personal computer, a notebook computer, a wireless phone, a server, a wireless base station, as local area network (LAN) equipment, a network access device (e.g., a broadband access device), a personal digital assistant (PDA), and so on.

The computing device 600 is illustrated as including various components. These components include, but are not limited as such, a processor 602 that implements at least one rotator/shifter 604, a volatile memory 606, a bus bridge 608, a nonvolatile memory 610 and an input/output (I/O) device 612. The components are coupled together by a high speed bus 614 and an I/O bus 616.

The rotator/shifter 604 included in the processor 602 may be similar to or the same as the rotator/shifter arrangement 100 described herein. As those skilled in the art appreciate, the rotator/shifter 604 may be employed in other ICs other than the processor 602 shown it the figure. Such other ICs include memories, buffers, amplifiers, receivers, transceivers, and intelligent switches.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A apparatus, comprising:
a first stage to receive an operand having a plurality of bits, the first stage to move at least one bit of the plurality of bits at least one bit position to produce a modified operand; and
a second stage coupled to the first stage, the second stage to receive the modified operand and to correct at least one bit associated with the modified operand that is incorrectly positioned.

2. The apparatus according to claim 1, further comprising a third stage coupled to the second stage, the third stage to receive an operand from the second stage, the third stage to perform one or more bit insertions when a logical shift operation is performed by the apparatus.

3. The apparatus according to claim 1, wherein the first stage includes four multiplexers.

4. The apparatus according to claim 1, wherein the first stage includes four eight-bit multiplexers.

5. The apparatus according to claim 1, wherein the second stage includes one thirty-two bit multiplexer that is to receive four eight bit operands from the first stage.

6. The apparatus according to claim 1, wherein the first stage is to receive a thirty-two bit operand and is to separate the thirty-two bit operand into four eight bit operands, the first stage is to move at least one bit associated with each of the four eight bit operands not greater than eight bit positions.

7. The apparatus according to claim 1, further comprising a third stage to receive an operand from the second stage and to output an operand that has undergone a logic operation.

8. The apparatus according to claim 1, wherein the first stage is to move at least one bit of the plurality of bits not greater than seven bit positions to produce a modified operand.

9. A method at least in part implemented by a computer, comprising:
receiving an operand having a plurality of bits;
separating the plurality of bits into a plurality of eight bit operands; and
moving at least one bit associated with each of the plurality of eight bit operands at least one bit position, the moving resulting in at least one bit being incorrectly positioned in each of the eight bit operands.

10. The method according to claim 9, further comprising merging the eight bit operands and moving the incorrectly positioned bits.

11. The method according to claim 9, further comprising moving each of the incorrectly positioned bits to a correct bit position.

12. The method according to claim 9, wherein the receiving receives a double word operand.

13. A system, comprising:
an integrated circuit having a rotator/shifter arrangement, the rotator/shifter arrangement including,
a first stage to receive an operand having a plurality of bits, the first stage to move at least one bit of the plurality of bits at least one bit position to produce a modified operand, and
a second stage coupled to the first stage, the second stage to receive the modified operand and to correct at least one bit associated with the modified operand that is incorrectly positioned; and
a wireless interface communicatively coupled to the integrated circuit.

14. The system according to claim 13, wherein the rotator/shifter arrangement further includes a third stage coupled to the second stage, the third stage to receive an operand from the second stage, the third stage to perform one or more bit insertions when a logical shift operation is performed by the rotator/shifter arrangement.

15. The system according to claim 13, wherein the first stage includes four multiplexers.

16. The system according to claim 13, wherein the first stage includes four eight-bit multiplexers.

17. The system according to claim 13, wherein the second stage includes one thirty-two bit multiplexer that is to receive four eight bit operands from the first stage.

18. The system according to claim 13, wherein the integrated circuit is at least one processor.

19. The system according to claim 13, wherein the first stage is to receive a thirty-two bit operand and is to separate the thirty-two bit operand into four eight bit operands, the first stage is to move at least one bit associated with each of the four eight bit operands not greater than eight bit positions.

20. The system according to claim 13, wherein the first stage is to move at least one bit of the plurality of bits not greater than seven bit positions to produce a modified operand.
